(19) United States
(12) Patent Application Publication
(10) Pub. No.: US 2025/0385796 A1
(43) Pub. Date: Dec. 18, 2025

(54) System and Method for Generating Perceptual Reflex Encryption Keys Using Spatial Auditory Stimulus and Multimodal Reflex Signatures

(71) Applicant: SLC Corporation, Las Vegas, NV (US)

(72) Inventor: Travis M. McGregor, Las Vegas, NV (US)

(73) Assignee: SLC Corporation, Las Vegas, NV (US)

(21) Appl. No.: 19/237,411

(22) Filed: Jun. 13, 2025

Related U.S. Application Data
(60) Provisional application No. 63/660,278, filed on Jun. 14, 2024.

(51) Int. Cl. H04L 9/32; H04L 9/08

(52) U.S. Cl. CPC H04L 9/3239; H04L 9/088; H04L 9/3247

(57) ABSTRACT

A system and method of generating a perceptual reflex encryption key (PRE-Key) may include the following steps: 1) delivering a spatially modulated auditory stimulus from a mobile device to a human subject via a secure audio output interface; 2) capturing, using a MEMS sensor subsystem, an involuntary physical response of the human subject to the auditory stimulus; 3) determining a response latency Δt between stimulus delivery and the captured response; 4) extracting a perceptual feature vector based on neocortical response approximations; and 5) computing the PRE-Key by hashing a combination of the auditory stimulus parameters, the perceptual feature vector, the physical response, and the response latency.

### BACKGROUND

In an era dominated by digital communications, artificial intelligence, and quantum computing, the need for secure, human-centered modes of information exchange has grown increasingly urgent. Traditional encryption methods rely on computational complexity and algorithmic secrecy, which are becoming increasingly vulnerable to advances in machine learning, neural networks, and quantum decryption capabilities. As these systems evolve, they pose significant challenges to privacy, accessibility, and information sovereignty, especially for individuals whose sensory processing and cognitive models differ from the norm, creating patterns that address the entire human population.

At the same time, and seemingly unrelated, the visually impaired population possesses a unique sensory capacity and neurocognitive orientation, particularly with respect to auditory and spatial processing. Decades of research in neuroscience and psychoacoustics have shown that blind individuals often develop heightened sensitivity to sound localization, frequency discrimination, and temporal resolution. These traits suggest means of designing and deploying a secure communication system that leverages these enhanced capabilities in a way that is naturally inaccessible to machines, while simultaneously providing an inclusive and empowering modality for human interaction.

Previous approaches to accessibility have focused on adapting existing machine-readable formats (e.g., text-to-speech, braille encoding) for users who are blind. However, these systems remain within the interpretive reach of digital algorithms. What is lacking in the current art is a communication system designed from the ground up to be human-exclusive—specifically blind human-exclusive—by using the human sensory response not just as a recipient of information, but as the essential key to its decryption.

### SUMMARY OF THE EMBODIMENTS

The present invention addresses this gap by introducing a spatially modulated, machine-resistant sound encoding technique that inherently defies non-human interpretation. By using parameters such as precise spatial orientation, sub-perceptual frequency layering, and biologically paced signal delivery, the system exploits the embodied experience and perceptual schema of blind individuals to ensure secure, unreplicable decoding. In doing so, it reframes human physiology as a cryptographic system, establishing a new class of secure communication that is inaccessible to digital surveillance, automated decoding, and algorithmic inference.

The present invention discloses a system and method for generating Perceptual Reflex Encryption Keys (PRE-Keys) using spatially modulated auditory stimuli and multimodal human reflex signatures. The invention is modeled on the heightened spatial auditory perception of blind individuals, whose superior sensitivity to spatialized sound forms the basis for encoding data in a manner that aligns with innate human perceptual and reflexive pathways. By precisely controlling the frequency, spatial origin, and timing of auditory signals, the system triggers involuntary perceptual reflexes—such as head orientation and micro-muscular responses—that are captured and translated into unique, non-reproducible encryption keys. These reflex-based responses form a secure biometric layer intrinsically bound to human physiology and experience.

The resulting encryption is resistant to decryption by digital, binary, quantum, and AI systems, as it relies on real-time human sensory and neural integration for interpretation. In this paradigm, the human—starting with blind people, but not exclusive thereto—serves as both sensor and cipher, rendering the encoded content effectively inaccessible to non-human entities and computational decryption methods.

### BRIEF DESCRIPTION OF THE DRAWINGS

FIG. 1 shows an overview of the steps in generating the PRE-keyₜ.

FIG. 2 shows an overview flow of the steps to authenticate the user using the PRE-keyₜ.

### DETAILED DESCRIPTION OF THE EMBODIMENTS

### Introduction

The present invention introduces a novel machine-resistant sound encoding system that leverages the unique structure and perceptual capabilities of the human neocortex—particularly in individuals who are blind as a non-limiting foundation model—to create an unreplicable cryptographic key. Unlike conventional encryption methods that rely on binary logic or artificial intelligence, this system utilizes the auditory processing pathways of the brain as its foundation for secure communication.

The human neocortex, the biological seat of intelligence, processes auditory information in a way that is not merely interpretive but also integrative and reactive. Sound stimuli are first processed in the auditory regions of the neocortex and then involuntarily projected to evolutionarily older parts of the brain, which control instinctive reactions such as head movement. This reflexive response chain forms a psycho-acoustic perception loop that is fundamentally non-algorithmic and non-deterministic—qualities that are impossible to reproduce through conventional computing methods.

By targeting this response loop with spatially modulated auditory signals—precisely tuned in frequency, location, and timing—the invention initiates a cascade of neurological events that effectively serve as a human-exclusive decryption mechanism. The complexity of the neocortex, with its estimated 100,000 neurons and 5 million interconnections in just one square millimeter, ensures that the perceptual signature generated by this process is biologically unique, temporally dynamic, and inaccessible to digital replication or quantum inference.

This system transforms the act of listening into an act of secure decoding, where the human brain—not a digital processor—becomes the viable key. As a result, it offers a secure, inclusive, and biologically grounded method for transmitting information that cannot be intercepted, decoded, or mimicked by machines.

### Details

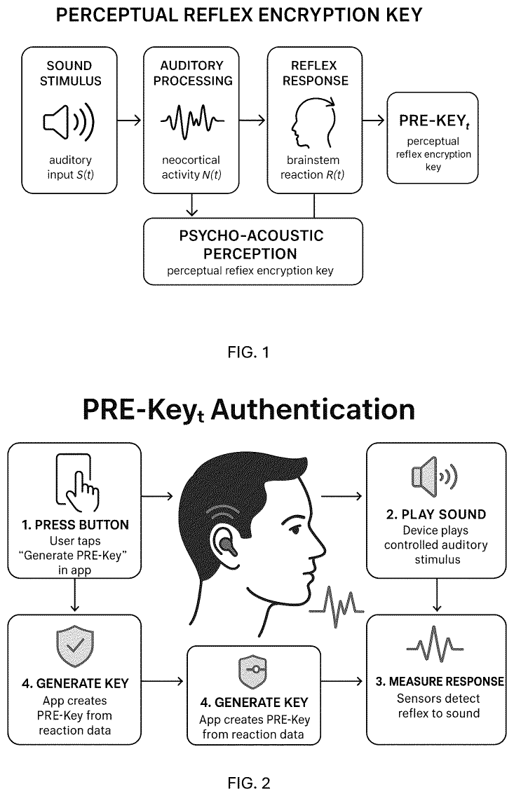

The present invention teaches a system and method for generating a non-deterministic, human-coupled encryption key, termed a Perceptual Reflex Encryption Key (PRE-Key). FIG. 1 provides an overview of the key generation process. By exploiting the psycho-acoustic response loop between auditory perception and instinctive motor reaction, the system and method may use a ETSI 3GPP standard Java Card or comparable firmware code structure operable with SIM or eSIM secure-silicon embedded in a mobile device(s) to deliver controlled audio stimuli and a MEMS-based sensor array to measure reflexive human responses.

### System Components:

Audio Stimulus Delivery Subsystem: SIM/eSIM with Secure Audio Payload. The SIM or eSIM stores one or more encrypted or encoded audio signals used as sound stimuli. Each stimulus signal may be digitally signed and time-sealed, and can only be decrypted and played on authorized mobile hardware. The SIM/eSIM interfaces with the mobile device's secure element and audio DAC (digital-to-analog converter) ensures hardware-rooted playback integrity.

Mobile Audio Output Interface: The audio signal is played through the device's speaker or directed to headphones (wired or wireless). Audio is designed with spatial, temporal, and frequency characteristics that are perceptually engaging but unpredictable by algorithms.

Human Response Capture Subsystem: MEMS Sensor Device. A wearable or embedded MEMS (Micro-Electro-Mechanical Systems) mobile device captures involuntary physical reactions to the auditory stimulus. Sensors may include a 6- or 9-axis IMU (inertial measurement unit) for capturing micro head turns, nods, or jerks. Optional: Skin conductance (GSR), muscle EMG, or inner ear vestibular MEMS for enhanced fidelity. Temporal Resolution: The MEMS subsystem is synchronized to a high-precision clock (±1 μs) shared with the mobile device to capture accurate Δt (response latency) values. Data Output: Captured response data is formatted into a reflex vector R(t), which includes magnitude, direction, onset delay, and sensor fusion confidence.

Key Generation Module Feature Extraction: The system and method may process S(t)=sound stimulus parameters from SIM or eSIM, N(t)=neocortical approximation (e.g., signal envelope, spatial cue interpretation), and R(t)=reflexive response vector from MEMS. These may be pre-processed via a bio-inspired perceptual model.

Hashing Function: A cryptographic hash function (e.g., SHA-512 or BLAKE3) may combine (S(t)∥N(t)∥R(t)∥Δt) into a one-time-use PRE-Key.

Key Characteristics: Each key may be non-reproducible without a human participant, be entropy-rich due to analog sensor variance, and resistant to replay or simulation due to temporal and motor noise uniqueness

### Operational Sequence:

Initialization—The user launches a secure app that activates the SIM/eSIM to provide the audio challenge.

Stimulus Delivery—The audio signal S(t) is played to the user via secure audio output.

Human Response—The MEMS device automatically records the reflex motion or reaction. The recording session is time-gated and tamper-proof.

Key Generation—Data is sent to a secure enclave in the device (e.g., ARM TrustZone or SE). A PRE-Keyₜ is computed and stored ephemerally for immediate cryptographic use.

Application—PRE-Keyₜ is used to encrypt/decrypt sensitive transactions, authenticate sessions, or verify human presence.

Perceptual Reflex Encryption Key (PRE-Key) Structure, Multimodal Key Components (M-KC). Each encryption key may include non-reproducible sensory event signatures that mimic the auditory→neocortex→brainstem reflex circuit. S(t): Unique sound stimulus pattern at time t, may be defined by: Frequency (Hz), Amplitude envelope, Spatial source location, Temporal modulations (microtiming). N(t): Simulated neocortical feature extraction output (e.g., spectrotemporal profile). R(t): Reflexive projection response simulated from pre-programmed reaction heuristics (mimicking subcortical reactions such as “head jerk vectors” or EMG signatures).

Key Forma: The key at timestamp t could be formatted as: PRE-Key_t=Hash(S(t)∥N(t)∥R(t)∥Δt),
where ∥=concatenation, Δt=microsecond-scale offset representing psycho-acoustic time-lag between S(t) and R(t).

Example: PRE-Key_t=SHA-512 (3D-audio [14 kHz, 45°, 0.5 s]∥Spectral-centroid-map∥Reflex-vector[+20° yaw, 50 ms latency]∥7 μs).

Integration with Private Node Blockchain Network: The present invention may further comprise a private node blockchain subsystem for secure, tamper-evident storage and validation of human-generated cryptographic materials derived from sensory-auditory interactions.

Blockchain Architecture: The blockchain system comprises one or more private permissioned nodes, operated by authorized entities such as device manufacturers, research institutions, or cybersecurity providers. Each node may run a Byzantine Fault Tolerant (BFT) or Proof-of-Authority (PoA) consensus mechanism to ensure high availability and resilience, without the computational overhead associated with public blockchains.

Secure Data Commitment Workflow: The blockchain subsystem may integrate with the following components:

1) Audio Stimulus Delivery Subsystem: Each encrypted audio payload transmitted from the SIM/eSIM includes a unique payload ID (PayloadID), a digital signature, and a secure timestamp. This metadata is registered on the blockchain before or at the time of playback to ensure immutable tracking of stimulus distribution events.

2) Mobile Audio Output Interface: The mobile device logs local playback confirmation, including PayloadID, DeviceID, and audio DAC signature hash. This playback confirmation is submitted to the blockchain for cross-verification with the originally issued payload.

3) Human Response Capture Subsystem: The MEMS-based reflexive response vector R(t), along with synchronized Δt (temporal delay), is cryptographically signed and hashed (see [018]) before submission to the blockchain. This ensures that human-generated responses tied to a specific audio event are securely time-stamped and uniquely linked to a biometric signature.

Blockchain Event Types: Each transaction recorded on the blockchain may include one or more of the following event types:

1) EventType: StimulusIssued—Logged when a new audio stimulus is issued and transmitted via SIM/eSIM. This includes PayloadID, hash of the audio payload, and signature of the issuer.

2) EventType: StimulusPlayed—Logged by the mobile device when playback is confirmed. Includes timestamp, DAC fingerprint, and proof of hardware playback integrity.

3) EventType: ReflexRecorded—Logged when the MEMS subsystem captures and hashes a human reflexive response. Includes R(t), Δt, and associated confidence levels.

4) EventType: PreKeyGenerated—Logs the final PRE-Keyₜ generated from S(t), N(t), R(t), Δt as defined in sections [017]-[019]. This record includes the one-time-use key hash and is optionally encrypted using a public key of the verifying node.

Decentralized Validation and Access Control, Access to the blockchain data may be controlled through hierarchical role-based permissions:

1) Data from SIM/eSIM (PayloadID, S(t)) is accessible only to the issuing authority.

2) Reflex vectors R(t) and PreKeyₜ can only be decrypted or validated by authorized medical, biometric, or authentication systems.

Each record may contain a zero-knowledge proof or Merkle root inclusion path to allow third parties to validate authenticity without revealing the original signal or human response data.

Privacy and Replay Resistance: The use of blockchain ensures that:
Every PRE-Keyₜ is provably unique and cannot be reused or simulated due to its dependency on temporal sensor noise and human reflex variability.
The association between a specific user, stimulus, and response is protected by storing only hashed data and signed events.
Attempts to replay audio stimuli without corresponding real-time reflex response will result in hash mismatch and key verification failure.

Use Cases Enabled by Blockchain Integration: Authentication Systems, PRE-Keyₜ can serve as a biometric access key validated against prior blockchain records. Digital Rights Management: Audio payload usage and reactions can be cryptographically bound to playback licenses, ensuring secure access and preventing unauthorized use.

Neuro-resilience Auditing: Longitudinal reflexive response data can be timestamped and validated for cognitive integrity tracking or medical diagnostics.

Music-Based Perceptual Reflex Encryption Key (PRE-Key): System introduced musical compositions as a covert stimulus method for generating and deciphering Perceptual Reflex Encryption Keys (PRE-Keys). Music functions as a non-reproducible multimodal keying mechanism, exploiting the reflexive and perceptual neuromechanics of the human auditory system—specifically those heightened in blind individuals—to generate encryption keys that are inherently immune to machine decryption.

This system and method are designed to generate a one-time, human-coupled encryption key (PRE-Keyₜ) through an involuntary response to a controlled audio signal. This PRE-Keyₜ is used for authentication or cryptographic operations and optionally logged on a private blockchain for tamper-evident auditability.

Step-By-Step User Journey begins with Enrollment & Initialization:

(1) The user downloads and installs a secure eSIM/SIM Applet via the Mobile Network Operator (MNO) over-the-air (OTA) to control data permissions with iOS, Android, and other Mobile Equipment (ME) Mobile Apps, which becomes a PRE-Key-enabled ME.

(2) With permission from the eSIM/SIM Applet, first, the secure pairing of the MEMS wearable (e.g., smart earbuds, headband, AR glasses, etc.) with the ME.

(3) SIM/eSIM is validated once pairing is complete and loaded with secure, time-sealed auditory payload(s).

(4) Stimulus Session Start-Begin the PRE-Key generation cycle.

(5) User taps “Generate PRE-Key” in the secure app.

(6) The Mobile App requests the SIM/eSIM to deliver an audio stimulus S(t).

(7) Blockchain logs EventType: StimulusIssued: (i) PayloadID, (ii). Audio hash+timestamp, (iii) Digital signature of issuer.

(8) Stimulus Delivery via Audio Output to Play a secure, perceptual-auditory stimulus.

(9) Secure DAC plays audio with spatialized, modulated, frequency-specific characteristics.

(10) Output verified by hardware playback proof (e.g., DAC fingerprint).

(11) Blockchain logs EventType: StimulusPlayed (i) DeviceID, PayloadID, (ii) time of playback, and (iii) Output integrity hash.

(12) Reflexive Human Response Detection to Capture subconscious physical reactions.

(13) The MEMS sensor subsystem (IMU, EMG, GSR, etc.) captures involuntary head movements or physiological reflexes.

(14) Temporal alignment with audio playback ensures Δt precision.

(15) Reflex vector R(t) and Δt computed with confidence metrics.

(16) Blockchain logs EventType: ReflexRecorded: (i) R(t), Δt, (ii) Reflex confidence, and (iii) Device and session metadata.

(17) PRE-Keyₜ Generation is to create the ephemeral human-coupled encryption key.

(18) Secure enclave extracts: (i) S(t)—sound stimulus parameters, (ii) N(t)—derived neocortical perceptual features, (iii) R(t)—MEMS response vector, and (iv) Δt—response latency.

(19) All parameters are hashed: PRE-Keyₜ=Hash (S(t)∥N(t)∥R(t)∥Δt).

(20) Blockchain logs EventType: PreKeyGenerated: (i) PRE-Keyₜ (one-time use, hash only) and (ii) Public key encrypted if access-controlled.

PRE-Key Verification Process Steps, as shown in FIG. 2: The PRE-Key is a one-time encryption key and is authenticated by tying it to reactions only the human user can produce—an involuntary physical reaction to a special sound that only the user's device plays.

(1) End User presses a button in the Mobile App that says “Generate PRE-Key.”

(2) The ME plays a special sound delivered from the SIM/eSIM to deliver an audio stimulus through the earbuds or device—a sound designed to trigger a tiny reflex in the body (like a quick head twitch or skin response). The End User does not consciously control this.

(3) The ME wearable sensors (e.g., smart earbuds or headband) instantly measure the user's reaction to that sound, like how fast and how strongly they responded.

(4) The app takes the (i) exact sound it played, (ii) how their brain likely perceived it, (iii) how the body reflexively reacted to it, and (iv) the time it took for the user to respond.

(5) The system and method of the Mobile App combines all that into a one-time key, the PRE-Keyₜ, using a special math formula (called a hash).

(6) This PRE-Keyₜ is unique to the End User and that exact moment. No one else could generate the same key, even with the same sound.

(7) The system logs proof of this entire process on a private blockchain—but only the final hashed key (not the End User's personal data), so it can be verified later without compromising the user's privacy.

### Structure

The invention may be implemented using a combination of dedicated hardware and specialized firmware or software that interact in a coordinated sequence. The structural elements may include:

### 1. Audio Stimulus Delivery Subsystem:

A SIM or eSIM chip embedded within a mobile device may contain encrypted, digitally signed auditory payloads. These payloads may be stored within a secure, tamper-resistant memory region on the SIM/eSIM. The chip interfaces with the mobile device's secure processor and digital-to-analog converter (DAC) to render the audio stimulus. The DAC ensures that the output audio signal matches secure playback standards and includes spatial and frequency modulations precisely encoded to elicit perceptual responses.

### 2. Mobile Audio Output Interface:

The DAC may be connected to one or more physical audio output devices, such as speakers, earbuds, or headphones that produce spatially modulated auditory signals. These audio signals may be generated through real-time control of stereo separation, frequency envelopes, and temporal modulation, resulting in sound patterns that are perceptually engaging to human subjects and resistant to digital replication.

### 3. Human Response Capture Subsystem:

A wearable MEMS sensor device (e.g., smart earbud, headband, or AR glasses) captures real-time physiological reactions. The MEMS device may contain at least one 6- or 9-axis inertial measurement unit (IMU), optionally supplemented with electromyography (EMG), galvanic skin response (GSR), or vestibular sensors. These components record reflexive responses such as head twitching or skin conductance variation with microsecond precision. Sensor readings are time-stamped and synchronized with stimulus delivery via a shared high-resolution clock module.

### 4. Processing and Key Generation Module:

The mobile device may include a secure processing enclave (e.g., ARM TrustZone or Secure Element) that performs real-time computation of the PRE-Key. This includes collecting the sound stimulus parameters (S(t)), computing a modeled neocortical perceptual signal (N(t)), and extracting the reflex vector (R(t)) and response latency (Δt). These components are concatenated and input into a cryptographic hash function, implemented in firmware or secure microcode, to generate the PRE-Key.

### 5. Secure Blockchain Logging Subsystem:

The device may communicate with a permissioned private blockchain network via authenticated network protocols. Event logs (e.g., audio stimulus issued, response recorded, key generated) may be structured as signed transactions. Each event is committed using Byzantine Fault Tolerant or Proof-of-Authority consensus algorithms to ensure immutability and traceability.

These interconnected hardware components and securely executed software routines provide a structural arrangement, including dedicated MEMS hardware, DAC-secured stimulus delivery, high-resolution synchronization modules, and integration with a blockchain infrastructure, is neither abstract nor general-purpose, but rather provides a specific machine-implemented architecture.

While the invention has been described with reference to the embodiments above, a person of ordinary skill in the art would understand that various changes or modifications may be made thereto without departing from the scope of the claims.

1. A method of generating a perceptual reflex encryption key (PRE-Key), the method comprising:
delivering at least one spatially modulated auditory stimulus from a mobile device to a human subject via a secure audio output interface;
capturing, using a MEMS sensor subsystem, an involuntary physical response of the human subject to the at least one auditory stimulus;
determining a response latency Δt between the at least one auditory stimulus delivery and the captured response;
extracting a perceptual feature vector based on neocortical response approximations; and
computing the PRE-Key by hashing a combination of parameters related to the at least one auditory stimulus, the perceptual feature vector, the physical response, and the response latency.

2. The method of claim 1, wherein the captured response comprises at least one of a head movement, muscle contraction, or skin conductance change.

3. The method of claim 1, wherein the MEMS sensor subsystem includes an inertial measurement unit (IMU) with at least six degrees of freedom.

4. The method of claim 1, further comprising verifying that the at least one auditory stimulus was played via a hardware-rooted secure DAC using a playback integrity hash.

5. The method of claim 1, wherein the perceptual feature vector includes a spectral centroid map and spatial localization cues.

6. The method of claim 1, wherein the PRE-Key is a one-time use key stored only in an ephemeral secure enclave of the mobile device.

7. The method of claim 1, further comprising logging a cryptographically signed event on a private blockchain for at least one of stimulus issuance, playback, reflex recording, or PRE-Key generation.

8. The method of claim 1, wherein the PRE-Key is used to authenticate a session, encrypt a transaction, or verify human presence.

9. The method of claim 1, wherein the at least one audio stimulus comprises spatialized sound patterns encoded with varying frequency, amplitude, and timing characteristics designed to elicit a reflexive response.

10. A system for generating and verifying a perceptual reflex encryption key (PRE-Key), the system comprising:
an audio stimulus delivery subsystem configured to output encrypted spatially modulated audio signals;
a human response capture subsystem configured to record involuntary reflexive responses to the audio signal, including time-synchronized data regarding direction, magnitude, and onset delay;
a processing module configured to extract stimulus parameters, compute perceptual features, and generate a PRE-Key using a cryptographic hash function; and
a blockchain subsystem configured to log cryptographically signed events, including stimulus issuance, playback confirmation, reflex recording, and PRE-Key generation.

11. The system of claim 10, wherein the human response capture subsystem includes a MEMS subsystem that includes wearable devices selected from the group consisting of smart earbuds, headbands, or augmented reality glasses.

12. The system of claim 10, wherein the blockchain subsystem is a private permissioned blockchain operating under a Proof-of-Authority consensus mechanism.

13. The system of claim 10, wherein blockchain records include zero-knowledge proofs or Merkle root hashes for verifiable but private authentication.

14. The system of claim 10, wherein the audio stimulus delivery subsystem is coupled to a SIM or eSIM applet that controls access to the audio payloads.

15. The system of claim 10, wherein playback confirmation includes a DAC fingerprint and a secure timestamp.

16. The system of claim 10, wherein the processing module uses SHA-512 or BLAKE3 to generate the cryptographic hash.

17. A non-transitory computer-readable medium storing instructions that, when executed by a processor of a mobile device, cause the device to:
initiate playback of a secure audio stimulus;
receive sensor data from a wearable MEMS device indicative of an involuntary user response to the audio stimulus;
compute a reflex vector and response latency;
derive a simulated neocortical perceptual output from the audio stimulus; and
hash parameters corresponding to the audio stimulus, perceptual output, reflex vector, and latency into a PRE-Key.

18. The computer-readable medium of claim 17, wherein the stimulus parameters include frequency, amplitude envelope, spatial source angle, and microtiming modulations.

19. The computer-readable medium of claim 17, wherein the instructions further include submitting reflex data to a blockchain node for audit logging.

20. The computer-readable medium of claim 17, wherein the response latency is measured with microsecond resolution based on a synchronized hardware clock.
